(19) United States
(12) Patent Application Publication
(10) Pub. No.: US 2006/0135090 A1
(43) Pub. Date: Jun. 22, 2006

(54) Antenna for a foldable radio device

(75) Inventor: Petteri Annamaa, Oulunsalo (FI)

Correspondence Address: DARBY & DARBY P.C., P. O. BOX 5257, NEW YORK, NY, 10150-5257, US

(73) Assignee: LK Products Oy, Kempele (FI)

(21) Appl. No.: 11/299,251

(22) Filed: Dec. 8, 2005

Related U.S. Application Data
(63) Continuation of application No. PCT/FI04/00342, filed on Jun. 4, 2004.

(30) Foreign Application Priority Data
Jun. 11, 2003 (FI) 20030874

(51) Int. Cl. H04B 1/034

(52) U.S. Cl. 455/95; 455/121

(57) ABSTRACT

An antenna intended for a foldable radio device, and a radio device with such an antenna. The first turning part (TP1) of the radio device includes the radio frequency transmitting and receiving amplifiers of the device, an antenna port (AP) and a first antenna element (320), by which the device has a signaling connection with the base stations of the radio network when the device is closed. The back part of the cover of the second turning part (TP2) or at least its surface is conductive. When the device is turned into the open position, the electromagnetic coupling between the conductive part of the outer cover (330) and said antenna element is strengthened so that the conductive part of the outer cover begins to function as a planar radiator at least in one of the operating bands of the device. In that case, the first antenna element functions as a feeding element for the radiator (331) formed by the conductive part of the outer cover. A better quality radio connection is achieved in the radio device during the actual network connection, compared to corresponding prior art radio devices, because the radiating surface is relatively large and is located on the outer cover of the device. The quality of the radio connection is achieved without needing to draw an antenna cable through the hinge between the turning parts of the device.

The invention relates to an antenna intended for a foldable radio device. The invention also relates to a radio device with an antenna according to the invention.

### BACKGROUND OF THE INVENTION

Foldable models have become increasingly common in commercial portable radio devices, such as mobile phones. They have two turning parts that are connected to each other with a hinge. The turning parts can be placed one on top of the other, or side by side. In the first mentioned or closed position, the device takes up particular little space, which is the benefit of a foldable structure. In this description and the claims, the term “closed” only refers to the position of the foldable radio device, and not to switching off the operating voltage. In the latter or open position, the device is kept during a network connection.

The antennas of foldable mobile phones are mostly monopole type external antennas. FIG. 1 shows an example of such known solution. The figure shows a foldable mobile station as turned into the open position. The mobile station comprises a first turning part TP1, which includes e.g. a keypad, and a second turning part TP2, which includes e.g. the display of the mobile station. A hinge HG connects the turning parts to each other. The mobile station has a helix antenna. The radiating helical conductor 120 is located at the outer end of the second turning part, i.e. at the end opposite to the hinge. The other radio frequency parts of the mobile station are located close to the end of the first turning part TP1 on the hinge side, and therefore a coaxial antenna line 110 is located between the radiator 120 and the first turning part for feeding and receiving.

A drawback of the structure shown in FIG. 1 is the above mentioned antenna line, which has to be taken over the hinged joint and is therefore a cumbersome solution with regard to production. In addition, there is the drawback that the helix causes an impractical protruding part in the structure. These drawbacks would be avoided by using an internal planar antenna inside the first turning part TP1, but in that case the antenna would have a small height because of the flatness of the turning part, and its electric characteristics would be therefore unsatisfactory.

### SUMMARY OF THE INVENTION

The purpose of the invention is to reduce the above mentioned drawbacks of the prior art. The antenna according to the invention is characterized in what is set forth in the independent claim 1. The radio device according to the invention is characterized in what is set forth in the independent claim 6. Some preferred embodiments of the invention are set forth in the other claims.

The basic idea of the invention is the following: The first turning part of the foldable radio device includes e.g. the radio frequency transmitting and receiving amplifiers of the device, an antenna port and at least one antenna element. By means of this first antenna element the device can have a signaling connection with the base stations of the radio network when the device is closed. The back, or the outer cover, of the second turning part or at least its surface is conductive. When the device is turned into the open position, the distance between the conductive part of the outer cover and the first antenna element becomes so small that the electromagnetic coupling between them strengthens significantly. The parts are dimensioned so that the conductive part of the outer cover then begins to function as a planar radiator at least in one operating band of the device. Thus the conductive part of the outer cover of the second turning part forms a second antenna element, which is fed through the first antenna element when the device is open.

The invention has the advantage that a better quality of the radio connection is achieved by a foldable radio device during the actual network connection, compared to corresponding prior art radio devices. This is based on the use of a relatively wide radiating surface located on the outer cover of the device. In addition, the invention provides the advantage that the quality of the radio connection is achieved without needing to draw an antenna line through the hinge between the turning parts of the device. A protruding antenna stopple is not necessary in the device, either. Furthermore, the invention has the advantage that the arrangement according to it is simple causing relatively low production costs.

### BRIEF DESCRIPTION OF THE DRAWINGS

In the following, the invention will be described in more detail. Reference will be made to the accompanying drawings, in which

FIG. 1 shows an example of a prior art antenna solution in a foldable radio device,

FIGS. 2a, b show an example of an antenna solution according to the invention in a foldable radio device,

FIGS. 3a, b show an example of an antenna feeding arrangement in a structure according to FIG. 2b,

FIGS. 4a, b show a second example of an antenna solution according to the invention in a foldable radio device, and

FIGS. 5a, b show an example of an antenna feeding arrangement in a structure according to FIG. 4b, and

FIG. 6 shows a third example of an antenna solution according to the invention in a foldable radio device.

### DETAILED DESCRIPTION OF THE INVENTION

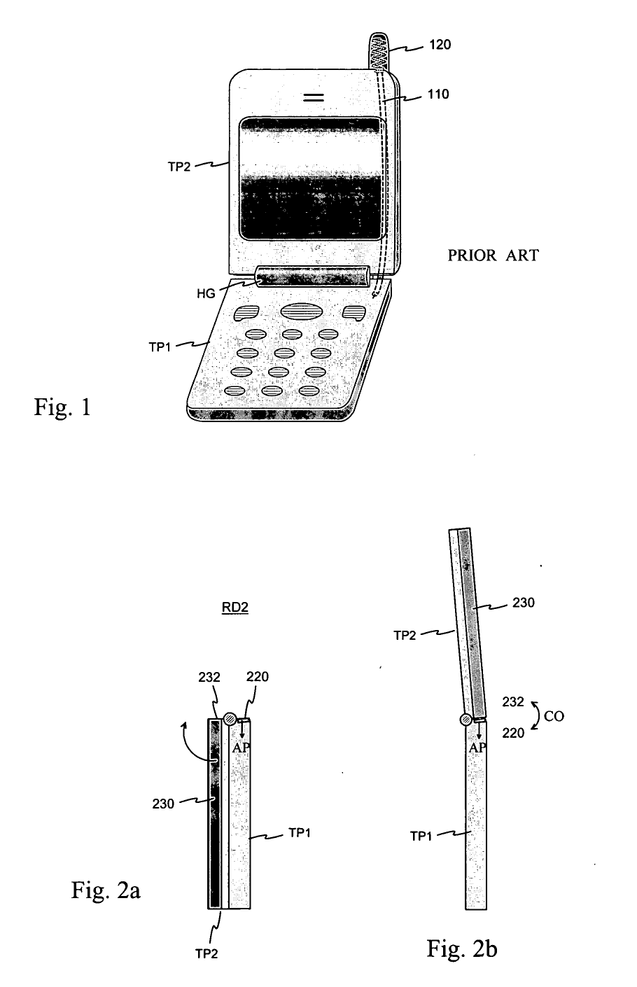

FIG. 1 was already explained in connection with the description of the prior art.

FIGS. 2a and 2b show an example of an antenna solution according to the invention in a foldable radio device. The radio device RD2 has a first turning part TP1 and a second turning part TP2. In FIG. 2a the device is closed, i.e. the turning parts are one on top of the other. The outer cover of the second turning part TP2 is entirely conductive or at least its surface is conductive, constituting the second antenna element 230. The outer cover means the part of the cover that is visible when the device is closed. The second antenna element is in this example the radiating main element of the antenna. In addition to a relatively wide planar part, the second antenna element has at least a side part 232 at the end that is close to the hinge between the turning parts. The first turning part TP1 includes the first antenna element 220, which is permanently coupled to the antenna port AP of the radio device. The antenna port again is coupled to the transmitter and receiver of the device. The first antenna element is located at the end of the first turning part that is close to the hinge. The first antenna element functions sufficiently well as a radio wave radiator and receiving element in a situation according to FIG. 2a, wherein it is sufficient that the signaling between the radio device and the base station succeeds.

In FIG. 2b the radio device RD2 is open. A mobile phone, for instance, is in this position during a call. The hinge side ends of the first and the second turning part of the radio device are now facing each other. Then the first antenna element 220 is against the side part 232 of the main element 230 in the second turning part, but galvanically insulated from it. As a result, there is a significant electromagnetic coupling CO between the first antenna element 220 and the whole main element through the side part 232. The strength of the coupling and the dimensions of the conductive parts are arranged so that the main element starts to oscillate at the operating frequencies of the radio device. Then the first antenna element 220 substantially functions only as a feeding element for the main element 230. Due to the wide radiating surface the antenna gain and hence the quality of the radio connection improve significantly as compared to the state in which the device is closed. This improvement does not require any wiring arrangements between the turning parts.

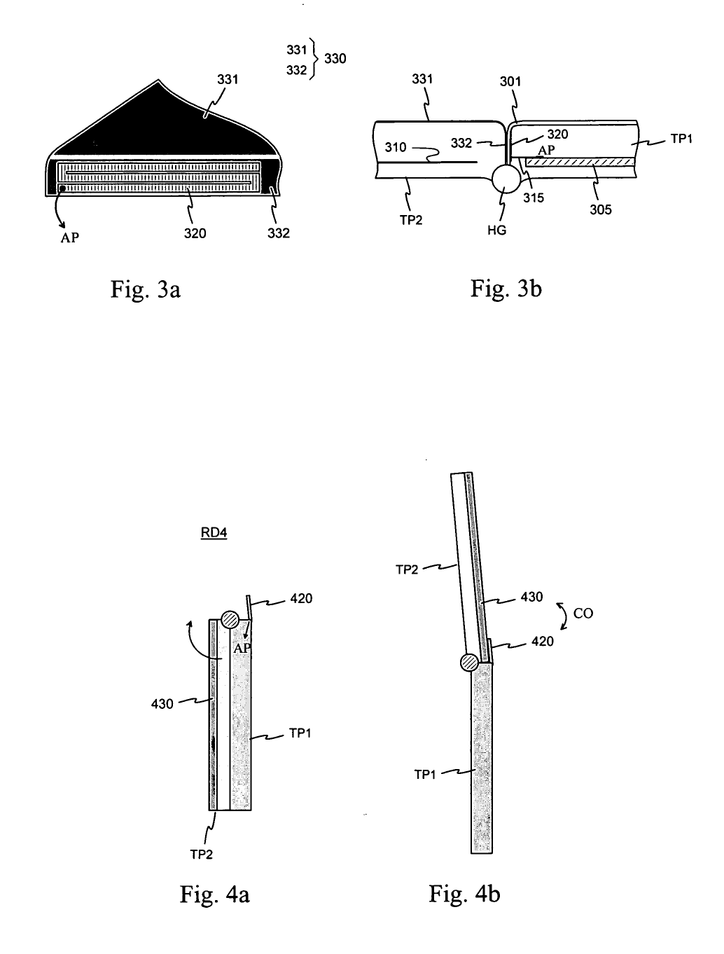

FIGS. 3a and 3b show an example of the antenna feeding arrangement in the structure and situation according to FIG. 2b. The radio device is then open, in which case the first antenna element 320 functions as a feeding element for the main element. FIG. 3a shows the main element 330 that corresponds to the main element 230 in FIGS. 2a and 2b as a perspective drawing and as cut so that its side part 332 and especially its wide planar part 331 are shown only partly. The side part 332 forms a rectangular bend in the main element. Against the side part in FIG. 3a there is a strip-like feeding element 320 connected to the antenna port AP.

FIG. 3b shows a longitudinal section of the radio device presented in FIG. 3a as simplified with regard to the antenna arrangement. In the second turning part TP2 of the device there is seen the wide planar part 331 and the side part 332 of the main element, which belong to the outer cover of the second turning part. In the second turning part, there is also seen its internal ground plane 310, which is a part of a resonator based on the main element 330. The feeding element 320 is in the first turning part TP1 of the device. In this example, the feeding element is fastened to the inner surface of the cover 301 of the first turning part at the end that is close to the hinge HG. The side part 332 of the main element is pressed against the outer surface of that part of the cover 301, and thus the cover 301 forms a dielectric layer that insulates the feeding element from the main element. The feeding element could also be within the cover of the first turning part or on its outer surface. In the latter case, the feeding element or the main element must be coated with a thin, dielectric layer. It/they may have such a layer in any case for protection reasons.

In the first turning part TP1, there is also shown its circuit board 305 and the feed conductor 315 that connects the feeding element 320 to the antenna port AP.

FIGS. 4a and 4b show a second example of an antenna solution according to the invention in a foldable radio device. The radio device RD4 has a first turning part TP1 and a second turning part TP2. In FIG. 4a the device is closed, i.e. the turning parts are one on top of the other. The outer cover of the second turning part TP2 is entirely conductive, or at least its surface is conductive, constituting the second antenna element 430. The second antenna element is also in this case the radiating main element of the antenna. The first turning part TP1 comprises the first antenna element 420 being located at the hinge end of the first turning part and being permanently coupled to the antenna port AP of the radio device. The first antenna element, together with a dielectric protecting and supporting layer, forms a protruding part at said end. The element 420 functions sufficiently well as a radio wave radiator and receiving element in a situation shown in FIG. 4a.

In FIG. 4b the radio device RD4 is open. The hinge side ends of the first and the second turning part of the radio device are now facing each other. The first antenna element 420 protrudes from the first turning part so that it presses against the wide planar surface of the main element 430, but galvanically insulated therefrom. Therefore, there is a significant electromagnetic coupling CO between the antenna element 420 and the main element 430. In this case, too, the strength of the coupling and the dimensions of the conducting parts are arranged so that the main element starts to oscillate at the same operating frequencies as the antenna of the first turning part alone. Again, the first antenna element 420 substantially functions only as a feeding element for the second antenna element 430.

The radio device RD4, as well as the device RD2 in FIGS. 2a and 2b can have more than one operation band, in which case also its antenna has at least a lower and higher operation band. When the radio device is closed, the radio connection is constituted by means of the first antenna element in all operation bands. When the radio device is open the second antenna element functions as a radiator in both/all operation bands.

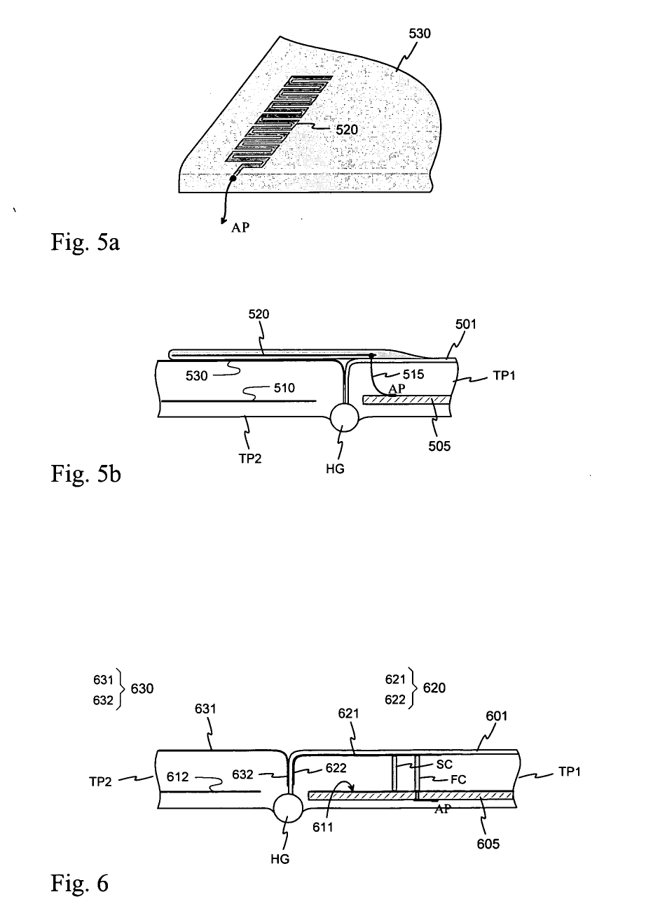

FIGS. 5a and 5b show an example of an antenna feeding arrangement in the structure and situation according to FIG. 4b. The radio device is then open, in which case the first antenna element 520 functions as a feeding element for the main element. FIG. 5a shows the main element 530 that corresponds to the main element 430 in FIG. 4 as a perspective drawing and cut so as only part of it is seen. Against the surface of the main element that is a part of the back wall of the second turning part there is a feeding element 520, which in this example is a meander shaped conductor strip. FIG. 5b shows a longitudinal section of the radio device presented by FIG. 5a as simplified in respect of the antenna arrangement. In the second turning part TP2 of the device there is seen the main element 530, which belongs to the outer cover of the second turning part. In the second turning part there is also seen its internal ground plane 510, which is a part of a resonator based on the main element 530. The meander strip 520 that forms the feeding element is embedded in a flat dielectric rod, which is mechanically joined to the cover 501 of the first turning part of the device. The main element 530 presses against the dielectric rod, which thus in this example forms the dielectric layer that insulates the feeding element from the main element. In the first turning part TP1, there is also seen its circuit board 505 and the feed conductor 515 that connects the feeding element 520 to the antenna port AP.

FIG. 6 shows a third example of an antenna solution according to the invention in a foldable radio device. The radio device is presented as a simplified longitudinal section, the device being open. The antenna arrangement is, for the part of the second turning part TP2, similar as in FIG. 3b: The second antenna element 630 has a bend at the end that is close to the hinge HG, which bend forms a side part 632 being located against the end of the first turning part TP1. In the first turning part TP1 there is now an internal PIFA-type antenna (Planar Inverted F-Antenna), which comprises a radiating plane 620, a ground plane 611 being located on the circuit board 605, a feed conductor FC and a short-circuit conductor SC. The radiating plane is located against the inner surface of the cover 601 of the first turning part. It has a main part 621 parallel with the ground plane and an extension 622 against the inner surface of the cover 601 at the end that is close to the hinge. That extension and the side part 632 of the second antenna element are facing each other separated by means of a dielectric layer formed by the cover. Thus the radiating plane 620 is the first antenna element according to the invention, by which element the second antenna element is fed electromagnetically. The structure can be dimensioned such that, when the device is open, either the first or second antenna element is the main radiator and one of them is correspondingly an auxiliary radiator. For example the PIFA has two bands, and the lower operation band is widened and the matching in the lower operation band is improved by means of the second antenna element.

Some antenna structures according to the invention have been described above. The invention does not limit the shapes and manner of realization of the antenna elements only to those described above. In the first turning part of the radio device there can be, in addition to the antenna element which functions as a feeding element, also a separate auxiliary antenna for ensuring a radio connection when the device is closed. The inventive idea can be applied in different ways within the scope defined by the independent claim 1.

1. An antenna for a foldable radio device comprising a first and a second turning part that are connected to each other by a hinge, the first turning part comprising radio frequency transmitting and receiving amplifiers and an antenna port, which antenna has at least a lower and higher operation band and comprises in the first turning part a radiating first antenna element coupled to the antenna port and in the second turning part a radiating second antenna element, and when the radio device is open, there is a sufficient electromagnetic coupling between the first and second antenna element for exciting oscillation in the second antenna element, in which case the first antenna element is arranged to function as a feeding element for the second antenna element, wherein
the second antenna element is a conductive part of outer cover of the second turning part, and
the first antenna element is plane-like and, when the radio device is open, is arranged to be pressed against a planar surface of the second antenna element to produce said electromagnetic coupling.

2. An antenna according to claim 1, wherein the second antenna element extending for its side part to an area of the hinge side end of the second turning part, and the first antenna element being located at the hinge side end of the first turning part in the direction thereof and arranged in this way to press close to said side part of the second antenna element when the radio device is open, in order to create said electromagnetic coupling.

3. An antenna according to claim 1, wherein the first antenna element being located in a protrusion joined to the hinge side end of the first turning part, which protrusion is arranged to press close to the second antenna element when the radio device is open, in order to create said electromagnetic coupling.

4. An antenna according to claim 1, wherein the first antenna element being a radiating plane of a PIFA, which radiating plane has an extension being located in the hinge side end of the first turning part, the extension being arranged to press close to the second antenna element when the radio device is open, in order to create said electromagnetic coupling.

5. An antenna according to claim 2, wherein, when the radio device is open, the second antenna element is a main radiator of the antenna and the first antenna element is first and foremost only said feeding element.

6. An antenna according to claim 4, wherein, when the radio device is open, the first antenna element is a main radiator of the antenna and the second antenna element is an auxiliary radiator at least in the lower operation band of the antenna.

7. An antenna according to claim 2 or 3, wherein the first antenna element being a monopol type conductor having a meander shape.

8. An antenna according to claim 1, further comprising in the first turning part a third antenna element, which is arranged to function as a radiator at least when the radio device is closed.

9. A radio device comprising a first and a second turning part that are connected to each other by a hinge and an antenna, the first turning part comprising radio frequency transmitting and receiving amplifiers and an antenna port, which antenna has as at least a lower and higher operation band and comprises in the first turning part a radiating first antenna element coupled to the antenna port and in the second turning part a radiating second antenna element, and when the radio device is open, there is a sufficient electromagnetic coupling between the first and second antenna element for exciting oscillation in the second antenna element, in which case the first antenna element is arranged to function as a feeding element for the second antenna element, wherein
the second antenna element is a conductive part of outer cover of the second turning part
the first antenna element is plane-like and, when the radio device is open, is arranged to be pressed against a planar surface of the second antenna element to produce said electromagnetic coupling.
